(19) United States
(12) Patent Application Publication
(10) Pub. No.: US 2008/0095990 A1
(43) Pub. Date: Apr. 24, 2008

(54) Camouflage coloring schemes and patterns

(75) Inventors: John Owen Boone, Charlotte, NC (US); David Sidney Oakley, Charlotte, NC (US)

Correspondence Address: MOORE & VAN ALLEN PLLC, P.O. BOX 13706, Research Triangle Park, NC, 27709, US

(73) Assignee: Carmoflage, LLC

(21) Appl. No.: 11/268,002

(22) Filed: Nov. 7, 2005

(51) Int. Cl. B41M 5/00

(52) U.S. Cl. 428/195.1; 428/919

(57) ABSTRACT

A camouflage coloring scheme is provided that includes a plurality of first images. Each of the plurality of first images represents an inanimate object or animate entity and comprising a first color. Each of the plurality of first images has substantially the same shape and size. The scheme comprises a plurality of second images, each of the second images representing an inanimate object or animate entity and comprising a second color. The second color is different from the first color, and wherein each of the plurality of second images has substantially the same shape and size. The first and second images comprise an affinity theme.

### FIELD OF THE INVENTION

The present invention relates generally to coloring schemes and patterns for articles, and more particularly to camouflage coloring schemes and patterns that include images.

### BACKGROUND OF THE INVENTION

Many camouflage coloring schemes and patterns (collectively, referred to hereinafter as “schemes”) are available. Some schemes include patches of varying and alternating colors that often include earth tone and natural environment colors. Such patches typically do not represent any particular image, but rather appear as blobs or splotches having irregular shapes that tend to obscure or confuse the outline of an article colored by the scheme so that the article blends into a natural environment. Other schemes include images of items found in the environment for which the scheme is intended, such as images of leaves and tree portions. Such images typically appear realistically sized and colored in order to help a camouflaged article of clothing or equipment to blend into natural forest environments. Conventional camouflage coloring schemes are typically found on clothing and other equipment intended for hunting or military purposes.

Cross-marketing is occurring between consumer markets directed toward hunting and consumer markets directed toward other activities, such as sports. For example, hats are available each having a particular sport team insignia emblazoned over a camouflage coloring scheme. Though such an insignia is not an element of a conventional camouflage scheme, and though the efficacy of a camouflage scheme toward concealment is typically compromised by the insignia, such a hat expresses the likes of the wearer toward several interests and, thus, engenders an affinity toward the hat in some consumers. Accordingly, a consumer might wear one hat having a camouflage coloring scheme and a bright sports insignia to a sporting event and wear another camouflaged hat without any bright insignias when hunting. Alternatively, a consumer might wear a camouflaged hat that is intended to conceal the consumer on a hunting trip and then adorn the hat with sports insignia pins and other accessories on other outings in order to express personal interests.

Accordingly, there is a need for improved camouflage schemes that better integrate the markets for camouflaged articles and the markets for articles that express personal interests and affinities, such as sports preferences, team preferences, corporate affiliations and other preferences for which consumers have affinities and affiliations. Such camouflage coloring schemes should provide the user with more flexibility and options to express interests, affinities, and affiliations. According to one embodiment, such improved camouflage coloring schemes should enable the user to express such preferences without necessarily reducing the concealing characteristic or effect of the camouflage.

### SUMMARY OF THE INVENTION

The present invention provides coloring schemes that include images that represent inanimate objects and/or animate entities creating affinity themes. According to one embodiment, the camouflage coloring scheme comprises a plurality of first images. Each of the first images represents an inanimate object and/or an animate entity and comprises a first color. Each of the plurality of first images has substantially the same shape, size and orientation. The scheme further comprises a plurality of second images. Each of the plurality of second images represents an inanimate object and/or an animate entity and comprises a second color. The second color is different from said first color, and wherein each of the plurality of second images has substantially the same shape, size, and orientation. Each of the plurality of first and second images comprises an affinity theme.

In one embodiment, the scheme comprises a background comprising a third color, wherein the third color is different from the first and second colors. In another embodiment, the first color has a first hue, the second color has a second hue, and the third color has a third hue, and wherein the third hue is the same as at least one of the first and second hues. In another embodiment, the first color is darker than the third color. In another embodiment, each of the plurality of first images comprises the first color and the third color. In another embodiment, the scheme further comprises a plurality of third images each representing at least one of an inanimate object or animate entity. In another embodiment, at least one of the plurality of first images interrupts at least one of the plurality of second images. In another embodiment, at least one of the plurality of second images interrupts at least one of the plurality of first images. In another embodiment, at least one of the plurality of first images intersects at least one other of the plurality of first images. In another embodiment, each of the plurality of first images represents an athlete, a plurality of athletes, or a mascot. In another embodiment, each of the plurality of first images represents an item of sporting equipment, a sports field, sporting apparel, a baseball diamond, or a racetrack. In another embodiment, each of the plurality of first images represents a motor vehicle, a military equipment item, a baseball, a baseball bat, a basketball, a basketball hoop, a football, a football helmet, a football goal post, a soccer ball, a soccer goal, a golf ball, a golf club, a golf club bag, a diving board, a hockey puck, a hockey goalie mask, a surf board, a snowboard, a skateboard, a musical instrument, a music accessory, a weapon, or a checkered flag. In another embodiment, each of said plurality of first images represents a food, a food container, a beverage, a beverage container, a beer container, a cigarette, a cigarette container, a smoking accessory, or a soft-drink container. In another embodiment, the affinity theme of each of the plurality of first images is related to a food supplier, a beverage supplier, or a service provider. In another embodiment, the affinity theme of each of the plurality of first images is related to a school, a club, an organization, a political group, a city, a state, a country, a flag, a business organization, a charity organization, a musical entity, an entertainment entity, or a religious group. In another embodiment, the affinity theme of each of the plurality of first images is related to a school entity, a sport team, a government entity, or a military entity. In yet another embodiment, the first color and the second color are school colors, team colors, or the colors of the flag of a government entity. In still another embodiment, the first color is beige, tan, brown, green, olive, grey, black, and white.

According to another embodiment of the invention, the camouflage coloring scheme comprises a plurality of first images. Each of the plurality of first images represents a motor vehicle and comprises a first color. Each of the plurality of first images has substantially the same shape and size. The scheme comprises a plurality of second images. Each of the plurality of second images represents a motor vehicle and comprises a second color. The second color is different from the first color, and wherein each of the plurality of second images has substantially the same shape and size. In one embodiment, each of the plurality of first images is disposed so as to have substantially the same orientation. In another embodiment, each of the plurality of second images is disposed so as to have substantially the same orientation. In another embodiment, each of the plurality of second images is disposed so as to have substantially the same orientation as each of the plurality of first images. In another embodiment, each of the plurality of second images has substantially the same shape and size as each of the plurality of first images. In another embodiment, the scheme further comprises a background upon which the plurality of first images and the plurality of second images are disposed. In yet another embodiment, each of the plurality of first images represents a racetruck. In still another embodiment, each of the plurality of first images represents a racecar.

According to another embodiment, the camouflage coloring scheme comprises a plurality of first images. Each of the plurality of first images represents an inanimate object and/or an animate entity and comprises a first color. Each of the plurality of first images has substantially the same shape and size. The scheme comprises a plurality of second images. Each of the plurality of second images represents an inanimate object and/or an animate entity and comprises a second color. The second color is different from the first color, and wherein each of the plurality of second images has substantially the same shape and size. Each of the plurality of first and second images comprises an affinity theme.

Accordingly, the present invention provides improved integration between the markets for camouflaged articles and the markets for articles that express personal interests such as sports preferences, team preferences and other preferences for which consumers have affinities and affiliations. Such camouflage coloring schemes provide the user with more flexibility and options to express interests, affinities, and affiliations. According to one embodiment, such improved camouflage coloring schemes enable the user to express such preferences without necessarily reducing the concealing characteristic or effect of the camouflage.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The foregoing and other advantages and features of the invention, and the manner in which the same are accomplished, will become more readily apparent upon consideration of the following detailed descriptions of embodiments of the invention taken in conjunction with the accompanying drawings, which illustrate preferred and exemplary embodiments and which are not necessarily drawn to scale, wherein:

FIG. 1 is a plan view illustrating a camouflage coloring scheme having images representing animate entities comprising athletes and inanimate objects comprising basketballs, according to an embodiment of the invention;

FIG. 2 is a plan view illustrating a camouflage coloring scheme having images representing inanimate objects comprising motor vehicles, according to another embodiment of the invention;

FIG. 3 is a plan view illustrating a camouflage coloring scheme having images representing inanimate objects comprising beverage products, according to another embodiment of the invention;

FIG. 4 is a plan view illustrating a portion of the coloring scheme of FIG. 1;

FIG. 5 is a plan view illustrating a portion of the coloring scheme of FIG. 3, wherein images are shown to each include more than one color;

FIG. 6 is a plan view illustrating a portion of the coloring scheme of FIG. 2, wherein images are shown to have substantially the same orientation;

FIG. 7 is a plan view illustrating a portion of the coloring scheme of FIG. 3, wherein images are shown to have substantially the same orientation;

FIG. 8 is a plan view illustrating a portion of the coloring scheme of FIG. 1, wherein images are shown to have substantially the same orientation; and

FIG. 9 is a plan view illustrating another camouflage coloring scheme having images representing inanimate objects comprising motor vehicles, according to another embodiment of the invention.

### DETAILED DESCRIPTION OF THE INVENTION

The present invention now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

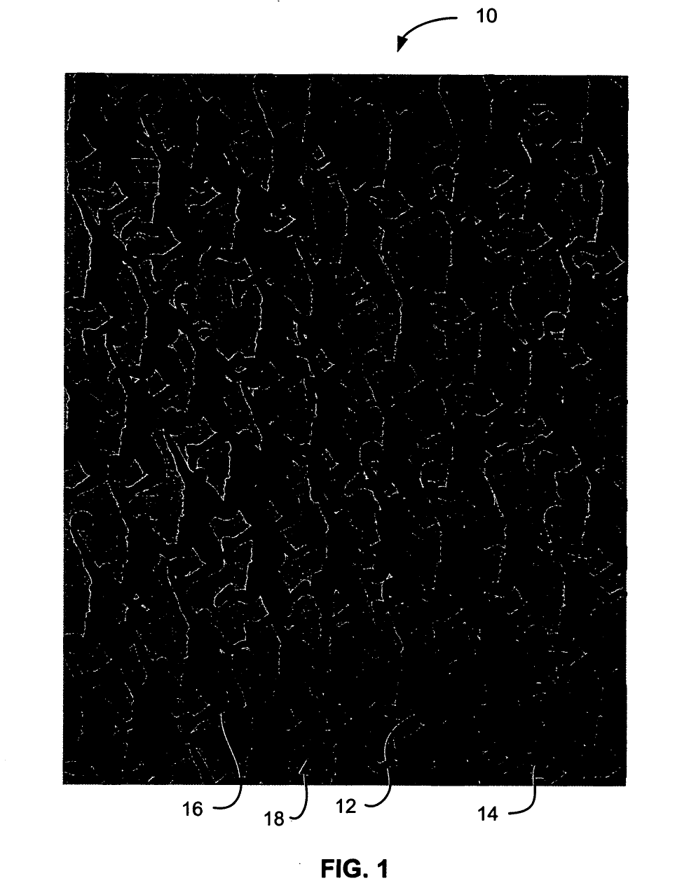

Referring to FIG. 1, there is illustrated a camouflage coloring scheme 10, according to an embodiment of the invention, that includes colored images. A first image 12 comprises a first color, a second image 14 comprises a second color, and a third image 16 comprises a third color. The first color, the second color and the third color are different from each other. The images of FIG. 1 are disposed on a background 18 that comprises a color that is different from each of the first color, the second color and the third color. The colored images in FIG. 1, namely the first image 12, the second image 14 and the third image 16, represent animate entities and inanimate objects. In particular, the images 12, 14 and 16 represent athletes with athletic equipment. Even more specifically, these images represent basketball players with basketballs. Although the camouflage coloring scheme 10 depicted in FIG. 1 includes both animate entities and inanimate objects, as discussed more fully below, the images can comprise only animate entities or only inanimate objects also. In addition, although the camouflage coloring scheme 10 depicted in FIG. 1 includes a first image 12, a second image 14 and a third image 16, in other embodiments of the invention, the scheme can include two images or four or more images.

The camouflage coloring scheme 10 illustrated in FIG. 1 includes the images 12, 14 and 16 that are differentiated from each other, and from the background 18, by their respective colors. Only one first image 12, only one second image 14, and only one third image 16 are specifically denoted by respective corresponding reference numerals in FIG. 1 so as not to obscure the illustration with repetitive reference numerals. Nonetheless, in FIG. 1 there is a plurality of first images 12, plurality of second images 14, and plurality of third images 16 that each comprise the same color as the corresponding image 12, 14, 16 denoted by a reference numeral. It should be understood that FIG. 1 is provided only as an example and that the camouflage schemes of the present invention are not limited to the colors depicted in FIG. 1 and further, the colors schemes can be concealing or non-concealing.

With regard to determining whether any two images have the same color or have different colors, color identifying schemes known as color spaces are conventional and are known to those of skill in the art. For example, in an “RGB” color space, any particular color can be identified by three ordered integer coordinates (red, green, blue) corresponding respectively to the intensities of red, green, and blue components of the particular color, wherein each coordinate is evaluated on a scale of 0 to 255. In one RGB space, the color of the first image 12 of FIG. 1 can be identified as having RGB coordinates approximately represented by (86, 58, 18). Furthermore, in this RGB space, the color of the second image 14 of FIG. 1 can be identified as having RGB coordinates approximately represented by (70, 85, 26), the color of the third image 16 of FIG. 1 can be identified as having coordinates approximately represented by (0, 0, 0), and the color of the background 18 of FIG. 1 can be identified as having coordinates approximately represented by (167, 154, 102). Thus, as any color can be identified by three RGB coordinates, any two colors can be objectively determined to be the same if they occupy approximately the same coordinates in a three dimensional RGB coordinate space. That is, two colors are identified as approximately the same if, within a particular RGB color space, their red coordinates are approximately the same, their green coordinates are approximately the same, and their blue coordinates are approximately the same. Similarly, any two colors can be objectively determined to be different where they do not occupy approximately the same coordinates in a three dimensional RGB coordinate space. That is, two colors are identified as different if their red coordinates are different, if their green coordinates are different, or if their blue coordinates are different.

Other color spaces are also conventional and known to those of skill in the art. For example, in an “HSV” color space, colors are defined in terms of hue, saturation, and value. Hue is related to color type and is denoted by a particular direction on a circular representation of the continuum of colors visible to the human eye. For example, red and green are denoted by different angular directions on the circular representation. Saturation is related to vibrancy or purity of color and is denoted by a distance from the symmetry axis in the circular representation. Pure vibrant colors such as those conventionally known as red and green are denoted by higher saturation, whereas faded or dulled colors with grey content are denoted by lower saturation. Value is related to the brightness of a color. A lower value corresponds to a dimly present color, whereas a high value corresponds to a strongly present color. A three dimensional HSV color space can be represented as right circular cone. Any particular color occupies a place within the cone as denoted by three ordered coordinates (hue, saturation, value). Value is denoted by a coordinate along the axis of the cone, saturation is denoted by distance from the axis, and hue is denoted by an azimuthal angular direction. A bright (high value) circular representation of colors occupies the broad circular base of the cone. The cone darkens along the value axis from the base to the black point.

In one HSV space, the color of the first image 12 of FIG. 1 can be identified as having HSV coordinates approximately represented by (35, 79, 34). In this HSV space, the first coordinate denotes hue evaluated on a scale of 0 to 359 like degrees on a compass with a continuum of colors disposed angularly about the center, the second coordinate denotes saturation evaluated on a scale of 0 to 100 with pure colors denoted by a saturation of 100 at the outer surface of the cone, and the third coordinate denotes value evaluated on a scale of 0 to 100 with utter darkness represented by a value of 0 at the point of the cone. Furthermore, in this HSV space, the color of the second image 14 of FIG. 1 can be identified as having HSV coordinates approximately represented by (75, 69, 33), the color of the third image 16 of FIG. 1 can be identified as having coordinates approximately represented by (0, 0, 0), and the color of the background 18 of FIG. 1 can be identified as having coordinates approximately represented by (48, 39, 65). Thus, as any color can be identified by three HSV coordinates, any two colors can be objectively determined to be the same if they occupy approximately the same coordinates in a three dimensional HSV coordinate space. Similarly, any two colors can be objectively determined to be different where they do not occupy approximately the same coordinates in a three dimensional HSV coordinate space.

Introducing the exemplary RGB and HSV color spaces should not be construed as binding these descriptions to any specific color model theory. These spaces are introduced to provide examples of modes by which colors may be determined as the same or as different. Other conventional and known color spaces by which color comparisons may be made include, but are not limited to, “HSL” color spaces, “CMY” color spaces, and “CMYK” color spaces.

The camouflage coloring schemes 10 according to the invention include images that represent animate entities and/or inanimate objects, such as the athletes and basketballs in FIG. 1. Preferably, the camouflage coloring schemes 10 according to the present invention include images of animate entities and/or inanimate objects having an affinity, affiliation, or association with a group, association or organization, including, without limitation, a club, sports team, sports league, a musician or other musical entity, an entertainment entity, business or legal entity (such as a corporation (whether for-profit or not-for-profit), partnership, sole proprietorship, limited liability company, limited partnership, etc.) having a particular cause or purpose or offering particular goods and/or services. As used herein, such affinity, affiliation or association is referred to as an “affinity theme.” For purposes of example only and not limitation, images of animate objects can include, without limitation, one or more individuals, such as athletes, or founders, leaders, or members of a group or organization, etc., or mascots of the team, group, or organization. The images of inanimate objects can include any inanimate object or symbol having an affiliation or association with the group, association or organization, including, without limitation, athletic equipment and symbols associated with athletes, sports teams and leagues (e.g., baseballs, footballs, basketballs, golf balls, soccer balls, golf balls, bowling balls, uniforms, helmets, bats, golf clubs, golf bags, goal posts, skateboards, snow boards, surf boards, wake boards, bicycles, sports team logos, sporting event logos, numbers and letters associated with athletes and teams such as jersey numbers of particular athletes, etc.); buildings or other facilities associated with sports teams and leagues, or business or legal entities; motor vehicles (e.g., cars, trucks, go-carts, three wheel vehicles, boats, aircraft (e.g., planes, jets, blimps, etc.), spacecrafts, mopeds, motorcycles, military vehicles (e.g., tanks, jeeps, etc.); bicycles; equipment, articles, and symbols associated with sovereign entities and military entities (e.g., military equipment items (e.g., weapons (such as guns and knives), boots, backpacks, hats, etc.), government logos, armed forces logos, etc.) and products, services, symbols and logos offered by or associated with business or legal entities (e.g., corporate logos, product logos, service logos, etc.), etc.

Further examples of inanimate objects represented by images according to one or more embodiment of the invention include, but are not limited to, consumer products, consumer technologies, appliances, electronic equipment, musical instruments and equipment (e.g., guitars and amplifiers), smoking related items (e.g., cigarettes, cigars, ashtrays, cigarette packs, etc.), toys, fictional characters, video game characters, video game logos, cartoon characters, pop culture icons and symbols, tattoos and other body art, skulls and crossbones, and flames. Further examples of animate entities represented by images according to one or more embodiment of the invention include, but are not limited to, athletes such as soccer players, football players, baseball players, golfers, bowlers, skateboarders, snow boarders, wake boarders, surfers, motorcyclists, bicyclists, off-road vehicle drivers, motocross riders; persons and groups having public notoriety such as politicians, entertainers, actors, movie stars, musicians, dancers, singers, rappers, and celebrities; tradesmen such as cowboys, truckers, and craftspersons; soldiers.

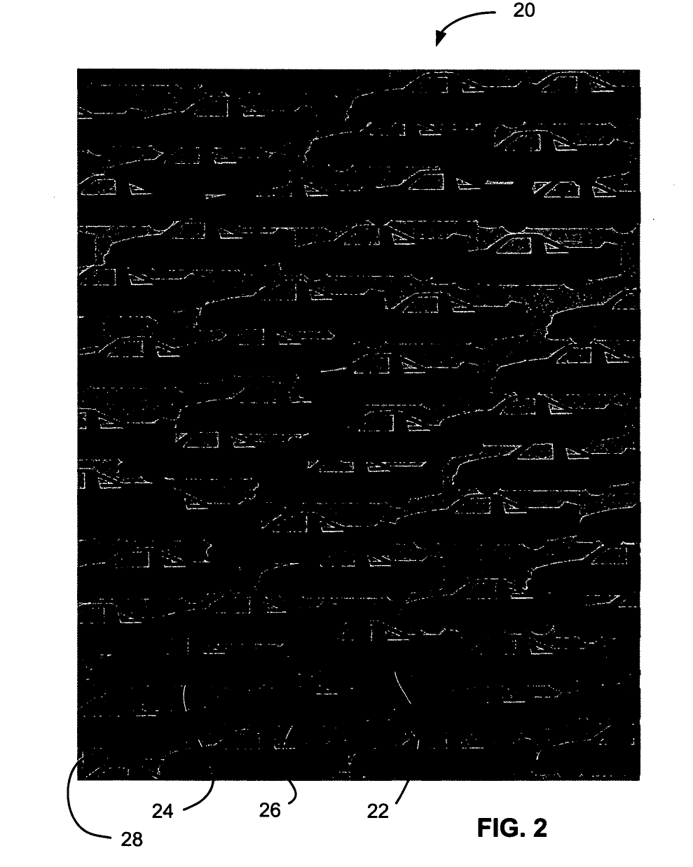

For example, referring to FIG. 2, there is illustrated a camouflage coloring scheme 20, according to another embodiment of the invention, that includes colored images that represent motor vehicles, which as depicted in FIG. 2 comprise racetrucks. A first image 22 comprises a first color, a second image 24 comprises a second color, and a third image 26 comprises a third color. The first color, the second color and the third color are different from each other. The images of FIG. 2 are disposed on a background 28 that comprises a color that is different from each of the first color, the second color and the third color. It should be understood that while the images in FIG. 2 represent racetrucks, other embodiments include images that represent other motor vehicles.

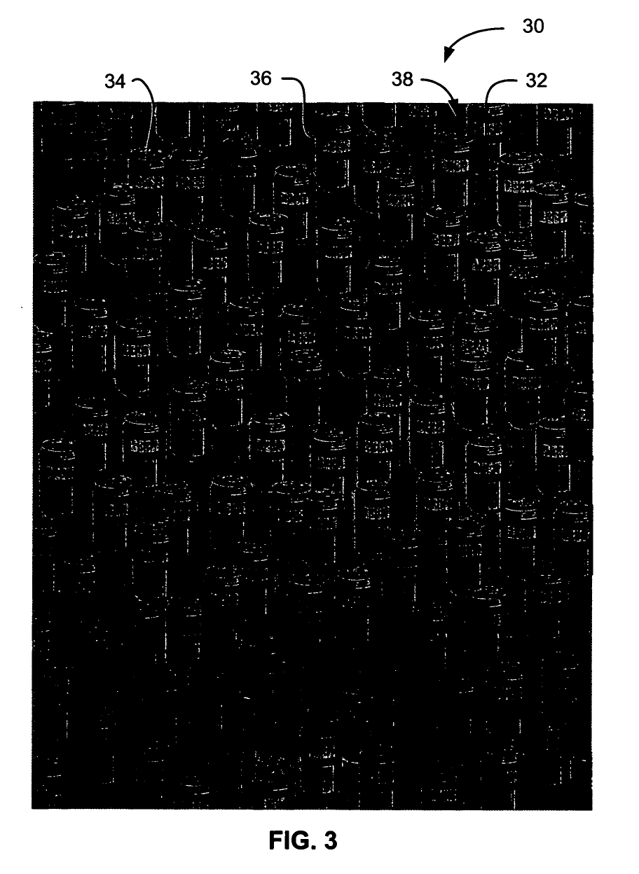

Referring to FIG. 3, there is illustrated a camouflage coloring scheme 30, according to yet another embodiment of the invention, that includes colored images that represent products available to consumers. A first image 32 includes a first color, a second image 34 includes a second color, and a third image 36 includes a third color. The first color, the second color and the third color are different from each other. The images of FIG. 3 are disposed on a background 38 that comprises a color that is different from each of the first color, the second color and the third color. The consumer products depicted in the images 32, 34 and 36 represent beverage containers and, more specifically, beer cans.

As noted above, the images in FIGS. 1-3 are intended to foster or generate affinities in people such as consumers, fans or supporters. For example, the images in FIG. 1 are intended to appeal to basketball fans, the images in FIG. 2 are intended to appeal to race fans, and the images in FIG. 3 are intended to appeal to beer drinkers. Other embodiments of the invention include images of insignias of particular sports teams or leagues, where such images are intended to appeal to the fans of the particular sports teams or league. Other embodiments of the invention include images that represent consumer products and business entities. Yet other embodiments of the invention include images of flags that represent particular entities, where such images are intended to appeal to people loyal to or interested in the particular entities. Given the many interests among consumers, fans and supporters, the camouflage coloring schemes of the present invention can embody many types of images. Insofar as a particular image fosters interest and affinity in some portion of the population, that image can be included in a camouflage coloring scheme according to the present invention.

Images included in camouflage coloring schemes according to various embodiments of the invention may be intended to attract the purchase of an article (such as a shirt, mug, hat, key chain, bag, etc.) having the camouflage color scheme or may be intended to entice the purchase of other articles or services represented by the images. That is, a particular shirt might have the camouflage coloring scheme of FIG. 3 for attracting a purchase of the shirt from a beer drinker. Furthermore, a second shirt having a second coloring scheme according to an embodiment of the invention might display images representing particular beer beverages of a particular brewer or beer distributor. The second shirt then defines an advertising medium by which particular products are advertised.

The particular colors of particular embodiments of camouflage coloring schemes may also be intended to foster or generate affinities in persons such as consumers. Images according to the invention can be colored by colors and combinations thereof including those shown in FIGS. 1-3 and colors other than those shown. Colors for images within coloring schemes according to the invention can correspond to colors associated with an entity or organization. For example, in one embodiment of the invention, a coloring scheme can include the colors associated with a school, a nationality, a team, a club, or any particular entity having preferred or associated colors. Similarly, a coloring scheme according to an embodiment of the invention can include colors associated with a business entity, a product, or a service.

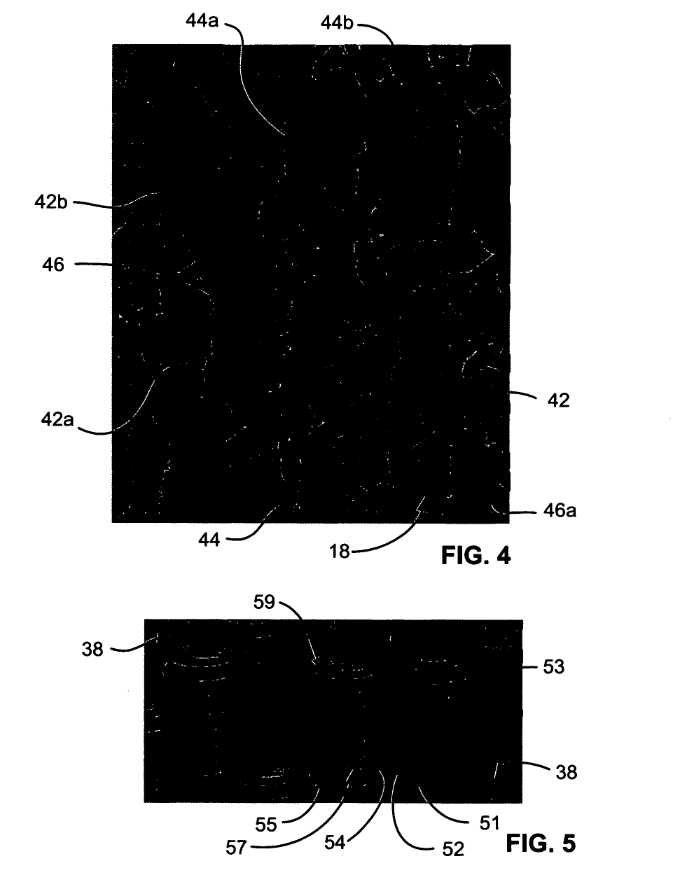

According to various embodiments of the invention, camouflage coloring schemes include images that represent inanimate objects and/or animate entities whether or not any particular image is whole or complete. For example, in FIG. 4, there is illustrated a portion of the camouflage coloring scheme 10 of FIG. 1. In FIG. 4, one particular first image 42 represents an athlete and basketball by way of a showing of a complete profile. A particular third image 46 represents an athlete despite the fact that portions of the athlete's legs are interrupted by the arm and head portions of a particular second image 44. Another second image 44a also represents an athlete and basketball despite the fact that portions of the athlete's legs are interrupted by the extended arm of another third image 46.

Regarding the meaning of the term “interrupt”, where a first image having a first color prevails over a second image having a second color, the first image is described herein as interrupting the second image. Furthermore, according to these descriptions, an interrupted image can have substantially the same shape and size as an uninterrupted image. For example, the first image 42 interrupts a third image 46 in that a foot portion of the first image 42 prevails over a knee portion of the third image 46. Nonetheless, the first image 42, the second image 44, the second image 44a, and the third image 46, and another third image 46a are hereby described as all having substantially the same shape and size even though only the first image 42 among these is whole and is completely uninterrupted. Thus, interrupted or not, and whole or not, each image in FIG. 4 has substantially the same shape and size as every other image in FIG. 4. It should be clear that the images in FIG. 4 are defined by areas having colors other than that of the background 18 which, in this example, has a light brown or beige color. It should be noted that the background 18 in FIG. 4 is interrupted only by images that each have substantially the same shape and size as each other image.

An innovation demonstrated in FIG. 4 provides a beneficial result in that the recognition of images is believed to be promoted when multiple images are provided to have substantially the same shape and substantially the same size, despite that each particular image may be interrupted, truncated, or obscured by intersections with other images. Thus, according to certain embodiments of the invention, multiple images are disposed to have substantially the same shape and substantially the same size. For example, recognition by observers of the images in FIG. 4 as representing athletes and basketballs may be promoted by the beneficial and innovative fact that multiple images therein have substantially the same shape and substantially the same size.

It should be further noted that images that have the same color may intersect in embodiments of camouflage coloring schemes according to the invention. For example, in FIG. 4, an arm portion of a first image 42a intersects a leg portion of the first image 42b. These images are not described herein as interrupting each other because they may not be differentiated by their colors. Nonetheless, the first image 42a and the first image 42b are hereby described herein as intersecting and as having substantially the same shape and substantially the same size.

Aesthetic blending of the camouflage coloring scheme 30 of FIG. 3 is achieved, as shown in the portion thereof illustrated in FIG. 5, by way of at least a coordination in the color of the first image 52 and the color of the background 38. The color of the background 38 is nominally referred to herein as a light brown color. The color of the first images 52 is referred to herein as a brown color. Therefore, the color of the first image 52 may be appreciated by some consumers as coordinated with the color of the background 38. Coordinated colors may appeal to the aesthetic tastes of some consumers and thus may entice a purchase of an article having coordinated colors according to one or more embodiments of the present invention.

It is demonstrated in FIG. 5 that an image within an embodiment of a camouflage coloring scheme according to the invention can include more than one color. For example, a portion of the camouflage coloring scheme 30 of FIG. 3 is shown in FIG. 5, wherein a first image 52 includes a first portion 51 having a first color, and a second portion 53 having a second color. The second portion 53 of the first image 52 is shaped to represent the letter “R” in the word beer. The second portion 53 is differentiated from the first portion 51 by color differentiation. For another example, a first portion 55 of a second image 54 has an olive color whereas a second portion 57 of the same image 54 has another color, in particular, that of the background 38.

It should also be noted that images according to various embodiments of the invention may include color portions that are not contiguous or that appear to be spaced by portions of a background. For example, referring to FIG. 5, a third portion 59 is a part of the second image 54 though the third portion 59 does not contiguously intersect the first portion 55. The portions 55 and 59 are parts of the image 54 that represents a beer can in that each represents a respective portion of the represented beer can whether or not the portions intersect. In particular, the portion 55 represents the body portion of a beer can and the portion 59 represents the cap portion of the same beer can. In another embodiment of the invention (not shown), a coloring scheme intended to appeal to people who enjoy cigarettes and coffee together comprises images that include cigarettes and coffee cups. That is, in that embodiment, a particular image includes a first portion representing a cigarette and a second portion representing a coffee cup, wherein the first portion and second portion are spaced from each other and are not contiguous.

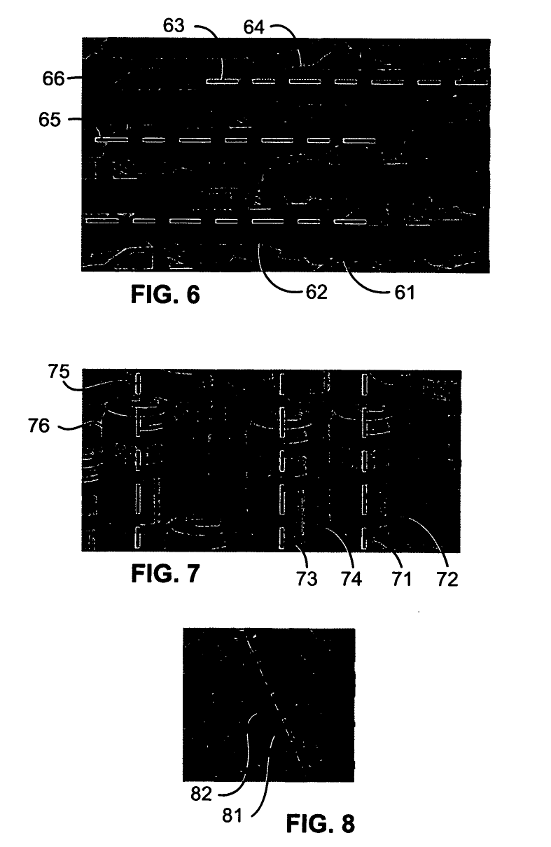

An innovation demonstrated in FIG. 6 provides a beneficial result in that the recognition of images is believed to be promoted when images are disposed to have substantially the same orientation according to certain embodiments of the invention. In particular, a first image 62 that represents an automobile is disposed along a longitudinal first axis 61, a second image 64 is disposed along a longitudinal second axis 63, and a third image 66 is disposed along a longitudinal third axis 65. The first image 62, second image 64, and third image 66 are all disposed to have substantially the same orientation in that the first axis 61, the second axis 63 and the third axis 65 are all substantially parallel to each other. This is similarly demonstrated in FIG. 7, wherein a first image 72 that represents a beer can, disposed along a longitudinal first axis 71, a second image 74, disposed along a longitudinal second axis 73, and a third image 76, disposed along a longitudinal third axis 75, are all disposed to have substantially the same orientation.

While not intending to be bound by any specific theory or explanation, it is believed that the disposition of images to have substantially the same orientation promotes the recognition of images because the human mind is capable of virtually completing interrupted, intersected, or truncated images by comparing discernable portions of multiple images. For example, the third image 46 in FIG. 4 may be recognized as an athlete despite substantial interruptions in the image because the interrupted portions of the image 46 can be assumed by comparing the image 46 to other images such as the first image 42 and the second image 44b. This comparison is facilitated by the innovative relative dispositions of these images to have substantially the same orientation. For another example, consumers will likely recognize the images in FIG. 1 as basketball players despite that the particularly denoted first image 12 may be the only image in the Figure that is not interrupted, truncated, or obscured by intersection.

It should be noted that axes of orientation are not limited to vertical or horizontal, but may be arbitrarily defined in discerning the orientation of an image. For example, in FIG. 8 an axis 81 at angle to the vertical axis is defined along the extended arm of the basketball player represented by the image 82.

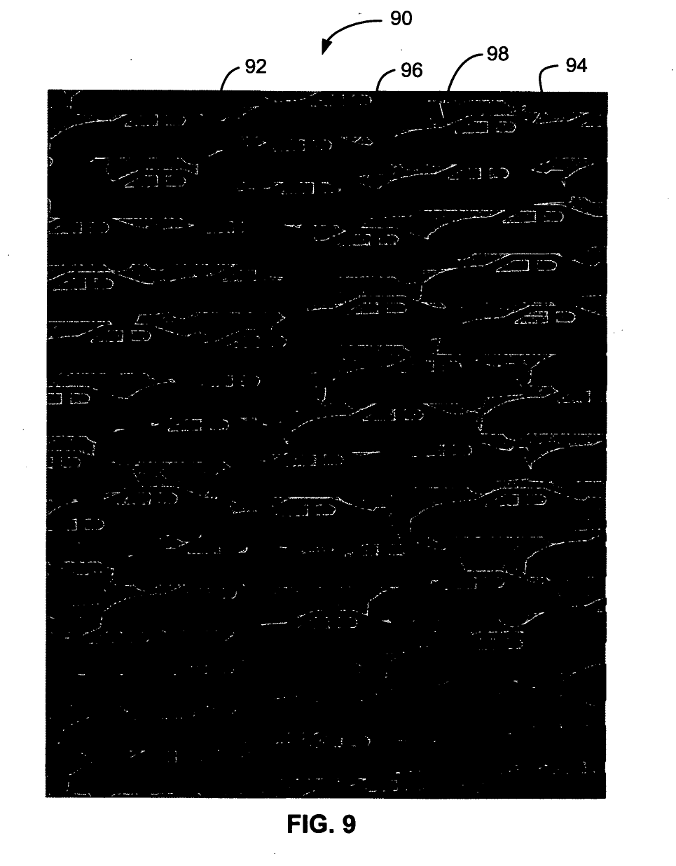

Referring to FIG. 9, there is illustrated a camouflage coloring scheme 90, according to another embodiment of the invention, that includes colored images that represent motor vehicles and, more specifically, racecars. A first image 92 comprises a first color, a second image 94 comprises a second color, and a third image 96 comprises a third color. The first color, the second color and the third color are different from each other. The images of FIG. 9 are disposed on a background 98 that comprises a color that is different from each of the first color, the second color and the third color. It should be understood that while the images in FIG. 9 represent racecars, other embodiments include images that represent other motor vehicles.

Coloring schemes according to various embodiments of the invention may be applied to various articles of wearing apparel, wherein such articles include, but are not limited to, jackets, ponchos, shirts, T-shirts, pants, shorts, skirts, hats, caps, visors, bandanas, shoes, boots, gloves, and mittens. Additionally, coloring schemes according to embodiments of the invention may be applied to articles related to or used in association with sporting events or team sport, wherein such articles include, but are not limited to, coolers, umbrellas, stadium blankets, seat cushions, insulated sleeves for beverage containers, team pennants, tents, awnings, chair seats and various other articles. Furthermore, coloring schemes according to embodiments of the invention may be applied to articles that may or may not be related to sports teams or sports events, wherein such articles include, but are not limited to, tarps, automobile covers, boat covers, tote bags, luggage, backpacks, sleeping bags, tents, lighters, firearms, holsters, gun bags, equipment cases, tool boxes, tools, and flashlights. It should be evident that the present invention is not limited to specific articles or to specific substrates. Embodiments of the invention coloring schemes can be implemented in a variety of articles using various substrate materials including woven materials, knitted materials, non-woven fabrics, films, foams, plastic, metal, wood and paper.

Coloring schemes according various embodiments of the invention may be applied to the surface of a fabric using known textile processing methods such as screen printing or transfer printing. When the substrate is a stock material fabric collected on a roll, a coloring scheme according to the invention may repeat along a dimension of the substrate. Coloring schemes according to various embodiments of the invention may be applied to an article by printing, painting, stamping, inking, or adhering. Coloring schemes according to the invention may be applied to labels, overlays, adhesive films, stickers, decals, and tapes such that a consumer or secondary manufacturer may further apply the schemes to any articles desired.

Thus, the present invention provides improved integration between the markets for camouflaged articles and the markets for articles that express personal interests such as sports preferences, team preferences and other preferences for which consumers have affinities and affiliations. The invention provides coloring schemes that include images that represent objects and entities of interest to consumers. The invention provides coloring schemes that can include colors that are associated with entities that are of interest to consumers. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A camouflage coloring scheme comprising:
a plurality of repetitive first images, each of said plurality of repetitive first images representing at least one of an inanimate object and animate entity and comprising a first color, and wherein each of said plurality of repetitive first images has substantially the same shape, size and orientation;
a plurality of repetitive second images, each of said plurality of repetitive second images representing at least one of an inanimate object and animate entity and comprising a second color, said second color being different from said first color, and wherein each of said plurality of repetitive second images has substantially the same shape, size, and orientation as said plurality of repetitive first images; and
wherein said first color comprises a greenish color and said second color comprises a brownish color so as to create a concealing color scheme that blends with environmental colors, but wherein each of said plurality of repetitive first and second images comprises an affinity theme defining a non-concealing pattern that does not blend with the environmental pattern so that said plurality of repetitive first images and said plurality of repetitive second images is accentuated by the relative shape, size and orientation of said first and second images to each other, the differences between said first color and said second color and the contrast between the concealing color scheme of said first and second colors and the non-concealing pattern of said plurality of repetitive first images and said plurality of repetitive second images.

2. The camouflage coloring scheme according to claim 1 further comprising a background, wherein said background comprises a third color, said third color being different from said first and second colors.

3. The camouflage coloring scheme according to claim 2 wherein said first color has a first hue, said second color has a second hue, and said third color has a third hue, and wherein said third hue is the same as at least one of said first hue and said second hue.

4. The camouflage coloring scheme according to claim 2 wherein said first color is darker than said third color.

5. The camouflage coloring scheme according to claim 2 wherein each of said plurality of repetitive first images comprises said first color and said third color.

6. The camouflage coloring scheme according to claim 1 further comprising a plurality of third images each representing at least one of an inanimate object and animate entity.

7. The camouflage coloring scheme according to claim 1 wherein at least one of said plurality of repetitive first images interrupts at least one of said plurality of repetitive second images.

8. The camouflage coloring scheme according to claim 1 wherein at least one of said plurality of repetitive second images interrupts at least one of said plurality of repetitive first images.

9. The camouflage coloring scheme according to claim 1 wherein at least one of said plurality of repetitive first images intersects at least one other of said plurality of repetitive first images.

10. The camouflage coloring scheme according to claim 1 wherein each of said plurality of repetitive first images represents an animate entity selected from the group consisting of an athlete, a plurality of athletes, and a mascot.

11. The camouflage coloring scheme according to claim 1 wherein each of said plurality of repetitive first images represents an inanimate object selected from the group consisting of an item of sporting equipment, a sports field, sporting apparel, a baseball diamond, and a racetrack.

12. The camouflage coloring scheme according to claim 1 wherein each of said plurality of repetitive first images represents an inanimate object selected from the group consisting of a motor vehicle, a military equipment item, a baseball, a baseball bat, a basketball, a basketball hoop, a football, a football helmet, a football goal post, a soccer ball, a soccer goal, a golf ball, a golf club, a golf club bag, a diving board, a hockey puck, a hockey goalie mask, a surf board, a wake board, a snowboard, a skateboard, a musical instrument, a music accessory, a weapon, and a checkered flag.

13. The camouflage coloring scheme according to claim 1 wherein each of said plurality of repetitive first images represents an inanimate object selected from the group consisting of a food, a food container, a beverage, a beverage container, a beer container, a cigarette, a cigar, a cigarette container, a smoking accessory, and a soft-drink container.

14. The camouflage coloring scheme according to claim 1 wherein said affinity theme of each of said plurality of repetitive first images is selected from the group consisting of a food supplier, a beverage supplier, and a service provider.

15. The camouflage coloring scheme according to claim 1 wherein said affinity theme of each of said plurality of repetitive first images is selected from the group consisting of a school, a club, an organization, a political group, a city, a state, a country, a flag, a business organization, a charity organization, a musical entity, an entertainment entity, and a religious group.

16. The camouflage coloring scheme according to claim 1 wherein said affinity theme of each of said plurality of repetitive first images is selected from the group consisting of a school entity, a sport team, a government entity, and a military entity.

17. (canceled)

18. (canceled)

19. A camouflage coloring scheme comprising:
a plurality of repetitive first images, each of said plurality of repetitive first images representing a motor vehicle and comprising a first color, and wherein each of said plurality of repetitive first images has substantially the same shape and size; and
a plurality of repetitive second images, each of said plurality of repetitive second images representing a motor vehicle and comprising a second color, said second color being different from said first color, and wherein each of said plurality of repetitive second images has substantially the same shape and size as said plurality of repetitive first images; and
wherein said first color comprises a greenish color and said second color comprises brownish color so as to create a concealing color scheme that blends with environmental colors, but wherein said plurality of first images and said plurality of second images define a non-concealing pattern that does not blend with the environmental pattern so that said plurality of first images and said plurality of second images are accentuated by the relative shape and size of said first and second images to each other, contrast between the concealing color scheme of said first and second colors and the non-concealing pattern of said plurality of first images and said plurality of second images, and the differences between said first color and said second color.

20. The camouflage coloring scheme according to claim 19 wherein each of said plurality of repetitive first images is disposed so as to have substantially the same orientation.

21. The camouflage coloring scheme according to claim 19 wherein each of said plurality of repetitive second images is disposed so as to have substantially the same orientation.

22. The camouflage coloring scheme according to claim 19 wherein each of said plurality of repetitive second images is disposed so as to have substantially the same orientation as each of said plurality of repetitive first images.

23. The camouflage coloring scheme according to claim 19 wherein each of said plurality of repetitive second images has substantially the same shape and size as each of said plurality of repetitive first images.

24. The camouflage coloring scheme according to claim 19 further comprising a background upon which said plurality of repetitive first images and said plurality of repetitive second images are disposed.

25. The camouflage coloring scheme according to claim 19 wherein each of said plurality of repetitive first images represents a race car.

26. The camouflage coloring scheme according to claim 19 wherein each of said plurality of repetitive first images represents a truck.

27. (canceled)
